(19) United States
(12) Patent Application Publication
(10) Pub. No.: US 2015/0324524 A1
(43) Pub. Date: Nov. 12, 2015

(54) INFORMATION PROCESSING APPARATUS, INFORMATION PROCESSING METHOD, AND NON-TRANSITORY COMPUTER READABLE MEDIUM

(71) Applicant: Fuji Xerox Co., Ltd., Tokyo (JP)

(72) Inventor: Kento HOSODA, Kanagawa (JP)

(21) Appl. No.: 14/550,136

(22) Filed: Nov. 21, 2014

(30) Foreign Application Priority Data
May 7, 2014 (JP) 2014-095875

(51) Int. Cl. G06F 19/00

(52) U.S. Cl. CPC G06F 19/322

(57) ABSTRACT

An information processing apparatus includes a receiving unit, an acquiring unit, an extracting unit, and a presenting unit. The receiving unit receives at least one document related to a treatment administered to a patient. The acquiring unit acquires a type of the document received by the receiving unit. The extracting unit extracts, from an association memory that stores a type of a first document and a type of a second document in association with each other, a type of a second document associated with the type of the document acquired by the acquiring unit, the second document being to be registered in a case where the first document is registered. The presenting unit presents the type of the second document extracted by the extracting unit for a document to be registered in conjunction with the document of the type acquired by the acquiring unit.

### CROSS-REFERENCE TO RELATED APPLICATIONS

This application is based on and claims priority under 35 USC 119 from Japanese Patent Application No. 2014-095875 filed May 7, 2014.

### BACKGROUND

1. Technical Field

The present invention relates to an information processing apparatus, an information processing method, and a non-transitory computer readable medium.

2. Summary

According to an aspect of the invention, there is provided an information processing apparatus including a receiving unit, an acquiring unit, an extracting unit, and a presenting unit. The receiving unit receives at least one document related to a treatment administered to a patient. The acquiring unit acquires a type of the document received by the receiving unit. The extracting unit extracts, from an association memory that stores a type of a first document and a type of a second document in association with each other, a type of a second document associated with the type of the document acquired by the acquiring unit, the second document being to be registered in a case where the first document is registered. The presenting unit presents the type of the second document extracted by the extracting unit for a document to be registered in conjunction with the document of the type acquired by the acquiring unit.

### BRIEF DESCRIPTION OF THE DRAWINGS

An exemplary embodiment of the present invention will be described in detail based on the following figures, wherein:

FIG. 1 illustrates a configuration example of conceptual modules of an exemplary embodiment of the present invention;

FIG. 2 illustrates a system configuration example in a case where the exemplary embodiment is implemented;

FIG. 3 illustrates an example of processing according to the exemplary embodiment;

FIG. 4 illustrates an example of processing according to the exemplary embodiment;

FIG. 5 is a flowchart illustrating an example of processing according to the exemplary embodiment;

FIG. 6 is a flowchart illustrating the example of the processing according to the exemplary embodiment;

FIG. 7 illustrates a data structure example of a document-type management table;

FIG. 8 illustrates an example of a document-registration-state screen;

FIG. 9 is a flowchart illustrating an example of processing according to the exemplary embodiment;

FIG. 10 illustrates a data structure example of a document-type management table;

FIG. 11 illustrates an example of a document-registration-state screen; and

FIG. 12 is a block diagram illustrating a hardware configuration example of a computer to implement the exemplary embodiment.

### DETAILED DESCRIPTION

Hereinafter, an example of an exemplary embodiment to implement the invention will be described with reference to the drawings.

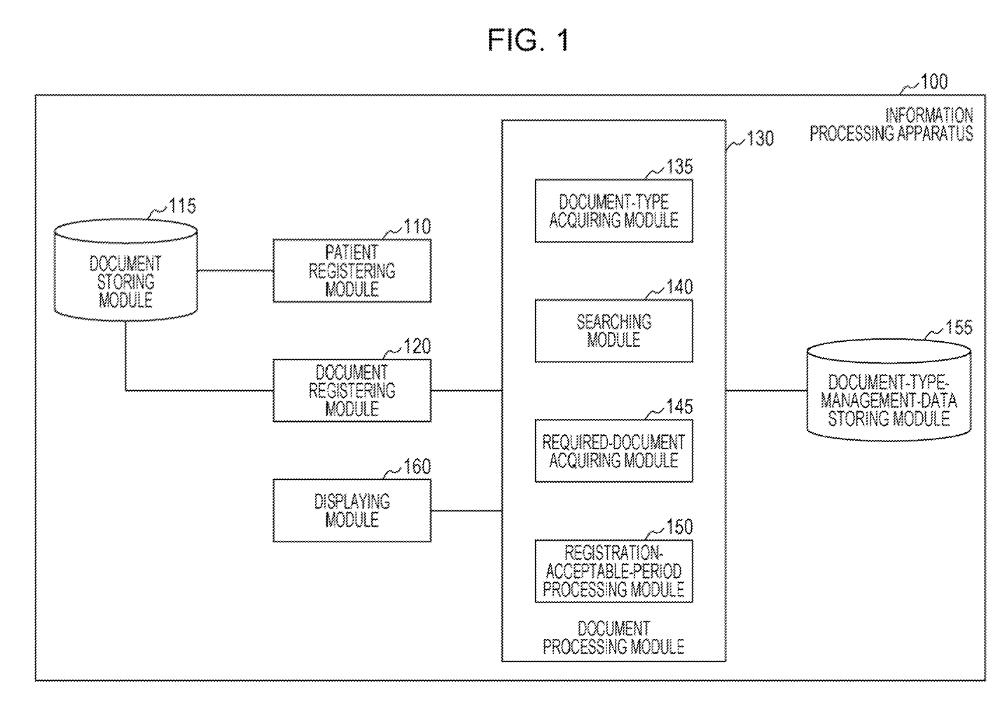

FIG. 1 illustrates a configuration example of conceptual, modules of the exemplary embodiment.

Note that the term “module” refers to generally logically separable components of software (computer programs) and hardware or the like. Modules in the exemplary embodiment thus refer to not only modules in a computer program but also modules in a hardware configuration. Accordingly, the description of the exemplary embodiment also serves as a description of a computer program for causing a computer to function as the modules (a program for causing a computer to execute steps, a program for causing a computer to function as components, and a program for causing a computer to implement functions) as well as a system and a method therefor. Meanwhile, the term “to store” and other terms equivalent to “to store” are used in descriptions. In a case where the exemplary embodiment describes a computer program, the term means storing something in a storage device or controlling something so as to store something in a storage device. The modules are provided for respective functions on a one-to-one basis. However, in implementing the functions, one program may constitute one module; one program may constitute multiple modules; and multiple programs may constitute one module. In addition, one computer may run multiple modules, and multiple computers may run one module in a distributed or parallel processing environment. Note that one module may include another module. Moreover, the term “connection” is used for not only a physical connection but also a logical connection (such as data exchange, instructions, or a reference relationship among data pieces). The term “predetermined” refers to having been determined before target processing. This term is used in such a manner as to include the meaning of being determined according to the situation at the determination time or to the situation thus far only before target processing, regardless of whether before or even after the start of processing in the exemplary embodiment. Meanwhile, in a case of multiple “predetermined values”, the values may be different from one another, or two or more of the values may be the same (including all of the values). Moreover, an expression meaning “if A, then B” is used in such a manner as to mean that “it is determined whether A holds true, and if it is determined that A holds true, then B is performed”. However, this excludes a case where the determination of whether A holds true is not needed.

A system or a device includes not only a configuration in which multiple computers, hardware, devices, and the like are connected to each other through a communication unit such as a network (including a communication connection on a one-to-one basis), but also a configuration in which a computer, hardware, a device, or the like is implemented. The terms “device” and “system” are used as terms having the same meaning. It goes without saying that the “system” does not include a mere social “system” built in accordance with agreements worked out by humans.

In addition, to perform a processing operation or multiple processing operations in each module, the module reads target information from a storage device for each processing, performs the processing, and writes a processing result to the storage device. Accordingly, explanations of reading the content from the storage device before processing and writing the content to the storage device after the processing are omitted in some cases. Here, the storage device may include a hard disk, a random access memory (RAM), an external storage medium, a storage device connected through a communication network, a register in a central processing unit (CPU), and other devices.

An information processing apparatus 100 according to the exemplary embodiment registers documents related to treatments administered to a patient. As illustrated in the example in FIG. 1, the information processing apparatus 100 includes a patient registering module 110, a document storing module 115, a document registering module 120, a document processing module 130, a document-type-management-data storing module 155, and a displaying module 160. The information processing apparatus 100 is designed particularly for a quantitative audit of a medical chart, which is a document related to treatments of a patient. Here, the term “quantitative audit” refers to verifying the presence of a target medical chart (registration of a medical chart that is an electronic document).

The audit is performed after treatments are completed. Accordingly, if many days have passed since a treatment, necessary information (a medical care record) might fail to be acquired. In addition, for example, even if a health insurance claim form (medical fee bill submitted to the health insurance society by a medical institution) is determined to be questionable, and if a medical care record is absent, it is not possible to determine what constitutes a correct health insurance claim form.

There is a limit on auditing validity on the basis of a health insurance claim form resulting from the medical care records. This leads to the need for auditing whether medical care records that are an information source of the health insurance claim form are properly registered. The audit is referred to as a medical chart audit.

However, a medical action is performed flexibly depending on the condition of the patient, and thus it is difficult to define a treatment pattern while the patient is in the hospital and undergoing treatment. For this reason, even if treatment administered to the patient without audit failure is desired, a treatment-pattern-definition-based method does not enable a correct-solution treatment pattern (set of medical care records) to be defined in advance, the correct-solution treatment pattern being for determining whether medical care records are properly registered.

The information processing apparatus 100 in the exemplary embodiment defines a set of documents required to be registered, on a registered document type basis, instead of on a treatment pattern basis. When a document is registered, the information processing apparatus 100 dynamically updates the documents required to be registered.

The patient registering module 110 is connected to the document storing module 115, and registers patient information. For example, the patient information is registered when the patient undergoes the first medical examination or enters the hospital. The patient information includes at least information for uniquely identifying the patient in the exemplary embodiment and may further include such information as the name, address, and sex of the patient.

The document storing module 115 is connected to the patient registering module 110 and the document registering module 120. The document storing module 115 stores therein the patient information and documents for the patient. In other words, the document storing module 115 has a function (repository management) serving as a storage for registering and managing medical care records (documents related to treatments of the patient) on a patient basis. The patient information has a one-to-many (including one-to-zero and one-to-one) relationship with registered documents.

The document registering module 120 is connected to the document storing module 115 and the document processing module 130. The document registering module 120 receives a document related to a treatment administered to a patient and registers the document in the document storing module 115 in association with patient information of the document.

The document processing module 130 includes a document-type acquiring module 135, a searching module 140, a required-document acquiring module 145, and a registration-acceptable-period processing module 150. The document processing module 130 is connected to the document registering module 120, the document-type-management-data storing module 155, and the displaying module 160.

The document-type acquiring module 135 acquires the type of the document received by the document registering module 120. For example, the type is stored in the document as an attribute of the document and may be extracted from the document. A document type represents a category of the document and is defined for each document. Using object-oriented programming, a document is created by instantiating the type of document.

The searching module 140 searches the document-type-management-data storing module 155 to retrieve the document type acquired by the document-type acquiring module 135. Specifically, the searching module 140 searches a document-type-code column 710 (or a document-type-name column 720) in a document-type management table 700 (described later) to retrieve a target document type, the document-type management table 700 being illustrated in the example in FIG. 7.

The required-document acquiring module 145 extracts the type of each second document, the type being associated with the document type retrieved by the searching module 140. Specifically, the required-document acquiring module 145 may extract a value in a necessary-to-be-registered-document column 730 from the document-type management table 700 (described later) illustrated in the example in FIG. 7, the value being located in the same row as the document type retrieved by the searching module 140 in the document-type-code column 710.

In a case where the document registering module 120 receives multiple documents and where the type of the second document to be extracted by the required-document acquiring module 145 overlaps with the type of the second document already extracted, the required-document acquiring module 145 may omit extraction of the type. Note that the “case where the document registering module 120 receives multiple documents” refers to a case where a second or subsequent round of registration is made for the document for the patient. Since the type of the second document is extracted every time a document is registered, the already extracted document type does not have to be extracted. If a variance (described later) occurs, the document type is extracted because the extracted document type often does not overlap with the already extracted type of the second document. As a matter of course, if a variance occurs, but if at least one document type among document types to be extracted overlaps with the already extracted type of the second document, the overlapping document type is not extracted.

The registration-acceptable-period processing module 150 has a function of alerting an operator to the presence of any document yet to be registered. If the current date and time falls within a predetermined period in a registration-acceptable period for a second document to be registered, the registration-acceptable-period processing module 150 issues an alert indicating the presence of the second document.

The document-type-management-data storing module 155 is connected to the document processing module 130. The document-type-management-data storing module 155 manages a set of documents required to be registered, on a document-type basis. Specifically, the document-type-management-data storing module 155 stores types of a first document and second documents (hereinafter, also referred to as necessary to-be-registered documents) in association with each other. The second documents are required to be registered, if the first document is registered. A document type is defined for each document, and the document-type-management-data storing module 155 manages sets of necessary to-be-registered documents in such a manner as to associate each document type with necessary to-be-registered documents. The document type has a one-to-many (including one-to-zero and one-to-one) relationship with the necessary to-be-registered documents. Specifically, the document-type-management-data storing module 155 stores the document-type management table 700 (described later) illustrated in the example in FIG. 7.

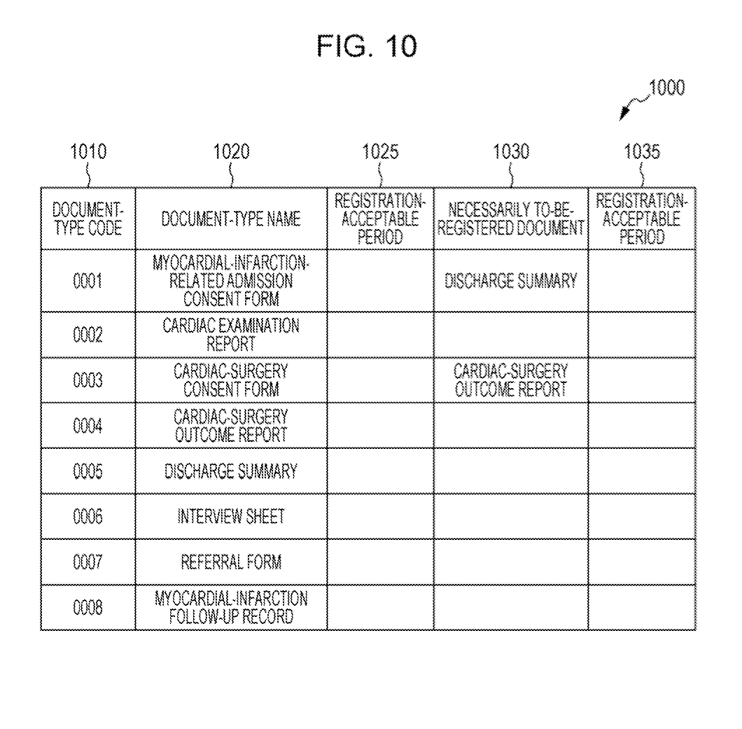

The document-type-management-data storing module 155 may further store registration-acceptable periods in which the second documents are required to be registered. Specifically, the document-type-management-data storing module 155 stores a document-type management table 1000 (described later) illustrated in the example in FIG. 10.

The displaying module 160 is connected to the document processing module 130. The displaying module 160 has a function of displaying documents required to be registered on a patient basis on a displaying device such as a liquid crystal display. The displaying module 160 presents the type of each second document extracted by the required-document acquiring module 145 as a document required to be registered in conjunction with the document acquired by the document registering module 120. In addition, when a document is registered, the displaying module 160 dynamically updates any document required to be registered. Information on the necessary to-be-registered document is acquired from the document-type-management-data storing module 155, and a registration state of the document is acquired from the document storing module 115.

When the registration-acceptable-period processing module 150 issues an alert, the displaying module 160 may present the alert indicating the presence of a second document required to be registered.

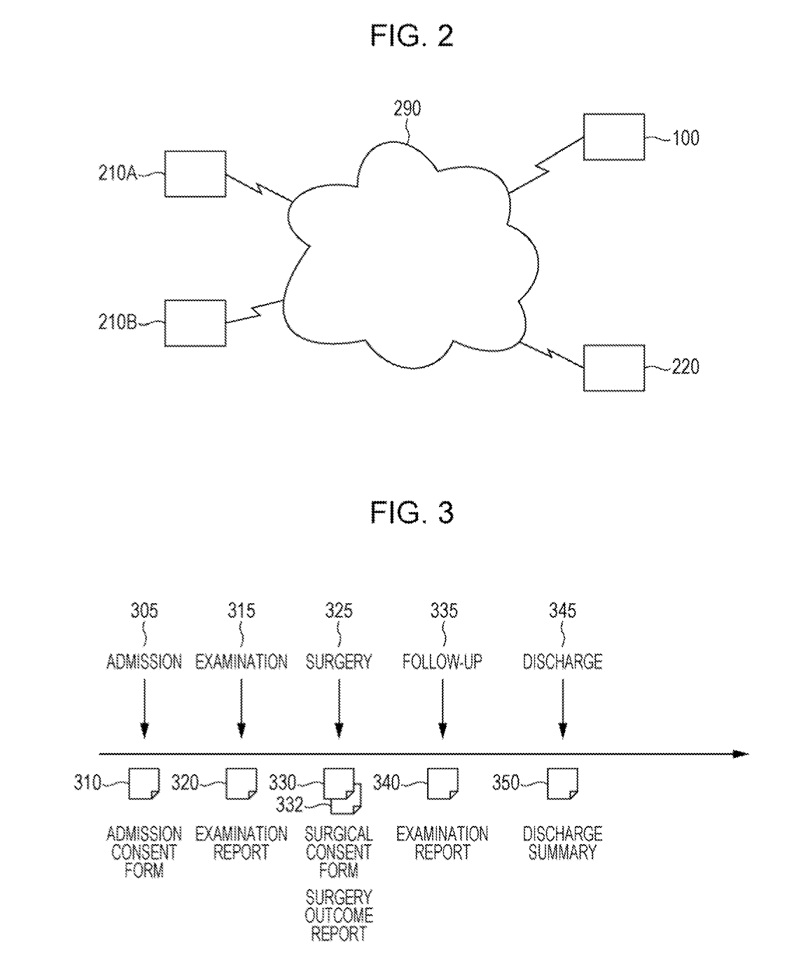

FIG. 2 illustrates a system configuration example in a case where the exemplary embodiment is implemented.

The information processing apparatus 100, a user terminal 210A, a user terminal 210B, and a document managing server 220 are connected to each other through a communication network 290. Each of the user terminal 210A and the user terminal 210B is also referred to as a user terminal 210, unless discrimination from each other is otherwise needed. The communication network 290 may be a wireless network, a wired network, or a network obtained by combining a wireless network and a wired network, and, for example, may be the Internet or an intranet that is a communication infrastructure. For example, an operator of the user terminal 210 uses the information processing apparatus 100 via a browser of the user terminal 210. Incidentally, an operator is typically a doctor. Examples of an operation include an operation of registering a patient, a document, or the like. The document managing server 220 may have a function of serving as the document storing module 115. In this case, the document storing module 115 is included in the document managing server 220, rather than in the information processing apparatus 100. It goes without saying that the document managing server 220 may be a device obtained by combining the information processing apparatus 100 with the document managing server 220; the information processing apparatus 100 with the user terminal 210; or the information processing apparatus 100, the user terminal 210, and the document managing server 220 together.

FIG. 3 illustrates an example of processing according to the exemplary embodiment.

In a general treatment pattern, for example, an admission consent form 310 is generated in association with an admission 305; an examination report 320 is generated in association with an examination 315; a surgical consent form 330 and a surgery outcome report 332 are generated in association with a surgery 325; an examination report 340 is generated in association with a follow-up 335; and a discharge summary 350 is generated in association with a discharge 345.

In this case, when the admission consent form 310 is registered, the displaying module 160 displays the necessity for the examination report 320, the surgical consent form 330, the surgery outcome report 332, the examination report 340, and the discharge summary 350 in the exemplary embodiment. This enables necessary to-be-registered documents to be known at the time of document registration. If the necessary to-be-registered documents are registered in accordance with the display, documents required for a health insurance claim form will have been registered when medical care is completed.

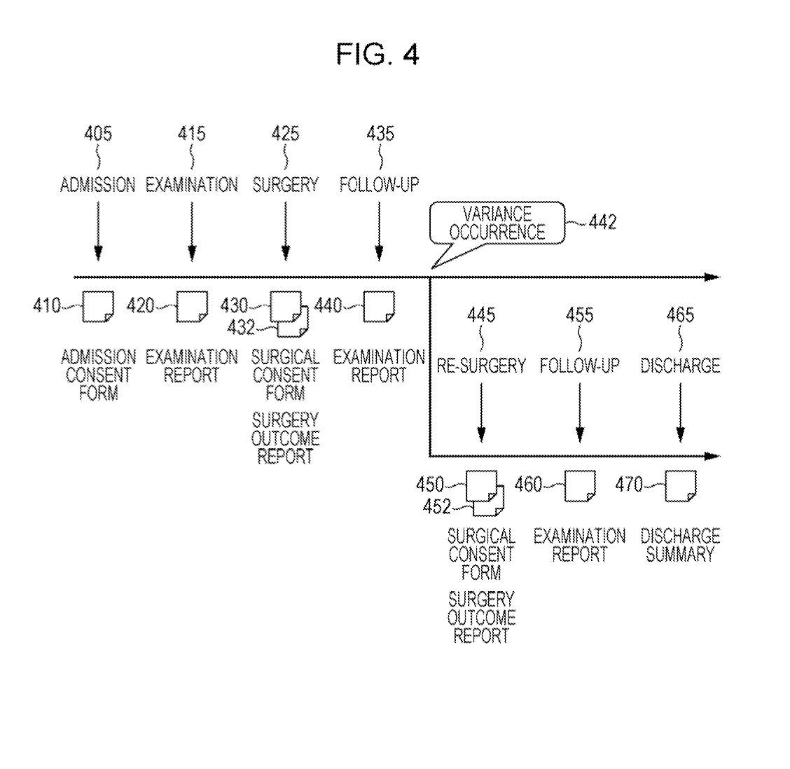

FIG. 4 illustrates an example of processing according to the exemplary embodiment, and illustrates an example in which the exemplary embodiment supports a “variance” frequently occurring during medical care. Note that a variance means a clinical course or an outcome that deviates from a process expected in a clinical path (timeline describing the procedures to be taken in treatments and medical examinations, the details of the procedures, and the order of the procedures). For example, adding an examination not scheduled in the clinical path, postponing the date of discharge from the hospital due to patient desire, or the like falls under a variance regarding the patient.

For example, an admission consent form 410 is generated in association with an admission 405; an examination report 420 is generated in association with an examination 415; a surgical consent form 430 and a surgery outcome report 432 are generated in association with a surgery 425; and an examination report 440 is generated in association with a follow-up 435.

In a case where a variance occurrence 442 is present during the follow-up 435, a surgical consent form 450 and a surgery outcome report 452 are generated in association with a re-surgery 445; an examination report 460 is generated in association with a follow-up 455; and a discharge summary 470 is generated in association with a discharge 465.

In this case, when the admission consent form 410 is registered, the displaying module 160 displays the necessity for the examination report 420, the surgical consent form 430, the surgery outcome report 432, the examination report 440, and the discharge summary 470 in the exemplary embodiment. When the surgical consent form 450 is registered, the displaying module 160 displays the necessity for the surgery outcome report 452, the examination report 460, and the discharge summary 470. Note that when the surgical consent form 450 following the variance occurrence 442 is registered, the discharge summary 470 to be extracted in conjunction with the registration of the surgical consent form 450 is not extracted. This is because the type of the discharge summary 470 would overlap with the type of the already extracted discharge summary 470 (discharge summary 470 extracted in conjunction with the registration of the admission consent form 410) and the overlapping would be detected. In other words, it is not indicated that both of the two discharge summaries 470 are required to be registered.

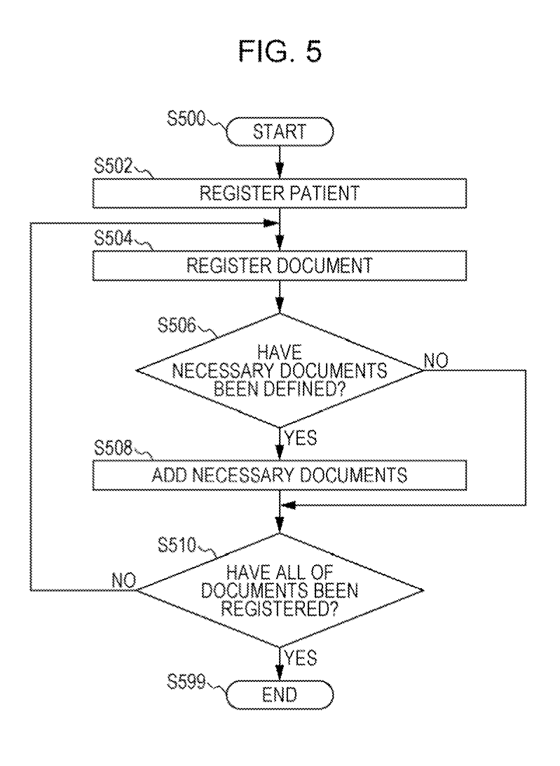

FIG. 5 is a flowchart illustrating an example of processing according to the exemplary embodiment. The flowchart illustrates an example of processing for document registration which occurs during a period from patient admission to discharge.

In step S502, the patient registering module 110 registers patient information that is information on a patient. In the exemplary embodiment, the processing starts with, for example, registering the patient who is to be treated. Specifically, the patient is registered when the patient enters the hospital. Upon registration of the patient, a repository for the patient is generated in the document storing module 115.

In step S504, the document registering module 120 registers a document. The document generated on the basis of the patient treatment is registered in the repository for the patient of the document storing module 115. Examples of the document include an admission consent form.

In step S506, the information processing apparatus 100 determines whether necessary documents have been defined. If the necessary documents have been defined, the processing proceeds to step S508. In the other cases, the processing proceeds to step S510. Specifically, the information processing apparatus 100 determines whether the necessary to-be-registered documents are defined for the document type of the document registered in step S504. The necessary to-be-registered documents are managed by using the document-type management table 700 in the document-type-management-data storing module 155.

In step S508, the information processing apparatus 100 adds the necessary documents. If it is determined in step S506 that the necessary to-be-registered documents have been defined, the displaying module 160 adds the necessary to-be-registered documents to documents displayed on the displaying device. Note that if the processing in step S508 is performed, the determination in next step S510 outputs “NO”.

In step S510, the information processing apparatus 100 determines whether all of the documents have been registered. If all of the documents have been registered, the processing is terminated (step S599). In the other cases, the processing returns to step S504. In other words, if the documents required to be registered have all been registered, the flow ends. If any document remains to be registered, the processing continues to wait for the document registration.

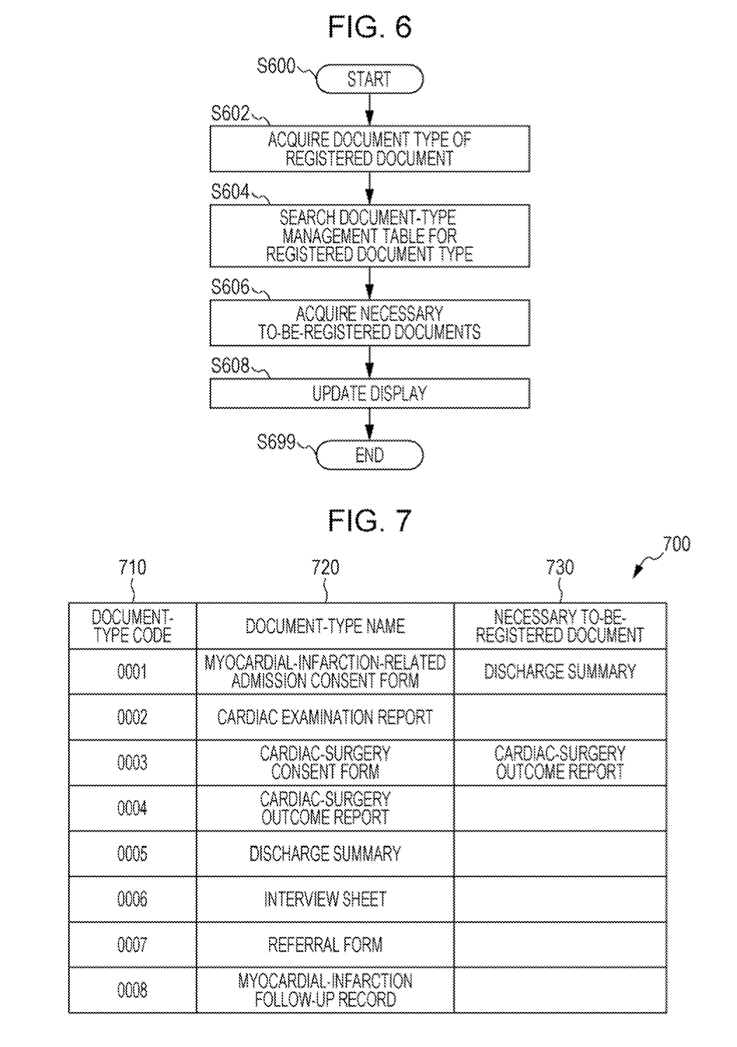

FIG. 6 is a flowchart illustrating the example of the processing according to the exemplary embodiment, and illustrates the details of the processing example of steps S506 and S508 in the flowchart in the example in FIG. 5. Here, a description is given of steps in which when the document is registered, the information processing apparatus 100 adds the necessary to-be-registered documents associated with the registered document.

In step S602, the document-type acquiring module 135 acquires the document type of the registered document, that is, the document-type attribute assigned to the document.

In step S604, the searching module 140 searches the document-type management table 700 to retrieve the registered document type, that is, a record corresponding to the acquired document type.

In step S606, the required-document acquiring module 145 acquires the necessary to-be-registered documents, that is, the necessary to-be-registered documents defined in the retrieved record.

In step S608, the displaying module 160 updates the display, that is, the display to indicate the added necessary to-be-registered documents on the displaying device. Specifically, the displaying module 160 adds items for the patient on a document-registration state screen, indicating that the documents have not been registered.

A description is given of an example of the document-type management table 700 stored in the document-type-management-data storing module 155. FIG. 7 illustrates a data structure example of the document-type management table 700.

The document-type management table 700 has the document-type-code column 710, the document-type-name column 720, and the necessary-to-be-registered-document column 730. The document-type-code column 710 has document-type codes stored therein; the document-type-name column 720 has document-type names corresponding to the respective document-type codes; and the necessary-to-be-registered-document column 730 has documents (necessary to-be-registered documents) required to be registered in conjunction with registration of each document assigned the corresponding document-type code. Note that FIG. 7 illustrates an example where the document-type names are stored in the necessary-to-be-registered-document column 730, but the document-type codes may be stored therein.

Here, each document type is conveniently assigned a document-type code. This enables the document types to be processed in a discriminating manner, even if the document-type names overlap with each other. Whether the document types overlap with each other may be determined by using the document-type code.

The document type is categorized as a consent form, a report, a summary, an interview sheet, a referral form, a record, or the like. Among these, the consent form is a document required for performing a certain medical action and is thus paired with an outcome report resulting from the medical action. For this reason, for a consent form, a corresponding outcome report may be defined as a necessary to-be-registered document. Note that this is not limited to the consent form, and necessary to-be-registered documents may be defined for any document type. For example, the necessary to-be-registered documents may also be defined by a manager in accordance with hospital operations. Note that a consent form is a document for proving that a patient has consented to receive medical care such as a surgery or to admission. The patient fills out the consent form describing whether to consent to receiving medical care in the next step. The discharge summary summarizes a clinical course and details of treatments from admission to discharge and describes the final diagnosis and the outcome.

If the patient does not consent to the medical care in the next step described in the consent form, there is a need to leave evidence of not performing the medical care, thus leading to a need for registering an associated document. For example, if the patient does not consent to a surgery described in a surgery consent form, there is a need to register a document recording the absence of consent and an outcome report describing that the surgery was not performed. These documents may be defined in the document-type management table 700.

In addition, each field in the necessary-to-be-registered-document column 730 may have multiple document types to be registered. In this case, the order of registering the document types may be defined. For example, the necessary-to-be-registered-document column 730 may indicate that the document types are to be registered in the field in the order of the document types.

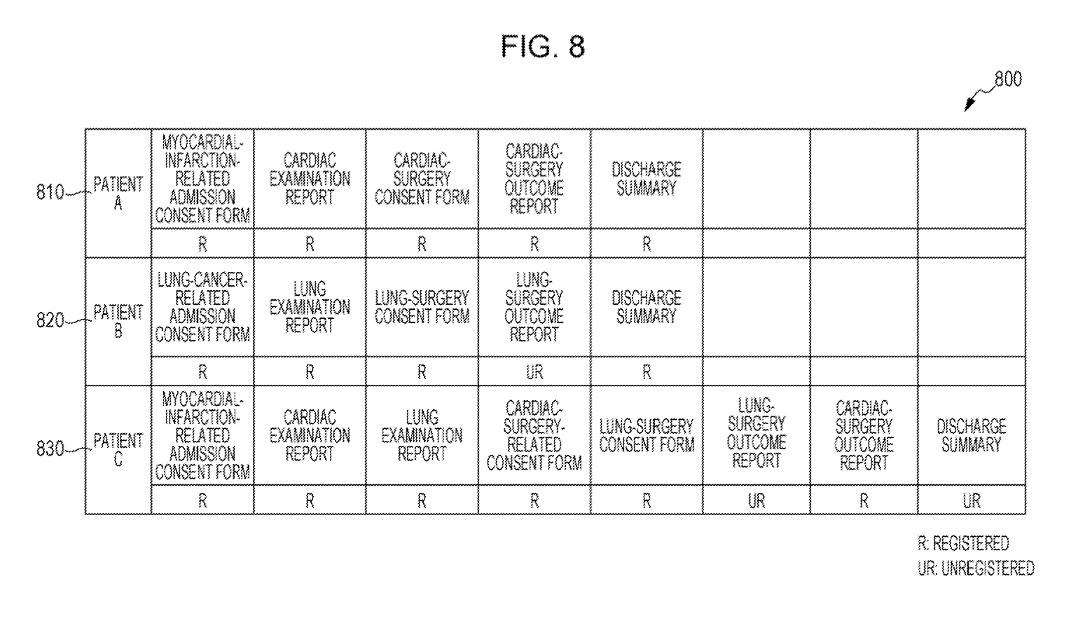

FIG. 8 illustrates an example of a document-registration-state screen 800. The displaying module 160 displays the document-registration-state screen 800 on the displaying device.

The document-registration-state screen 800 displays a patient-A row 810, a patient-B row 820, and a patient-C row 830, that is, necessary to-be-registered documents in a list for each patient (in a row in this case). “R” and “UR” are used to indicate an already-registered document and a document yet to be registered, respectively, thus enabling current registration states of the documents to be seen in a list. Upon registration of a document, documents defined as necessary to-be-registered documents are added to the list.

The patient-A row 810 has a “myocardial-infarction-related admission consent form”, a “cardiac examination report”, a “cardiac-surgery consent form”, a “cardiac-surgery outcome report”, and a “discharge summary” that have been registered therein.

The patient-B row 820 has a “lung-cancer-related admission consent form”, a “lung examination report”, a “lung-surgery consent form”, and a “discharge summary” that have been registered; and a “lung-surgery outcome report” that has not been registered.

The patient-C row 830 has a “myocardial-infarction-related admission consent form”, a “cardiac examination report”, a “lung examination report”, a “cardiac-surgery consent form”, a “lung-surgery consent form”, and a “cardiac-surgery outcome report” that have been registered; and a “lung-surgery outcome report” and a “discharge summary” that have not been registered.

From the document-registration-state screen 800 illustrated in the example in FIG. 8, it is understood that medical care is completed without registering the “lung-surgery outcome report” of the patient B.

As for the patient C, a lung surgery is needed after the cardiac surgery (a variance occurs), and the “lung-surgery consent form” is newly registered. Accordingly, the “lung-surgery outcome report” is added as a necessary to-be-registered document.

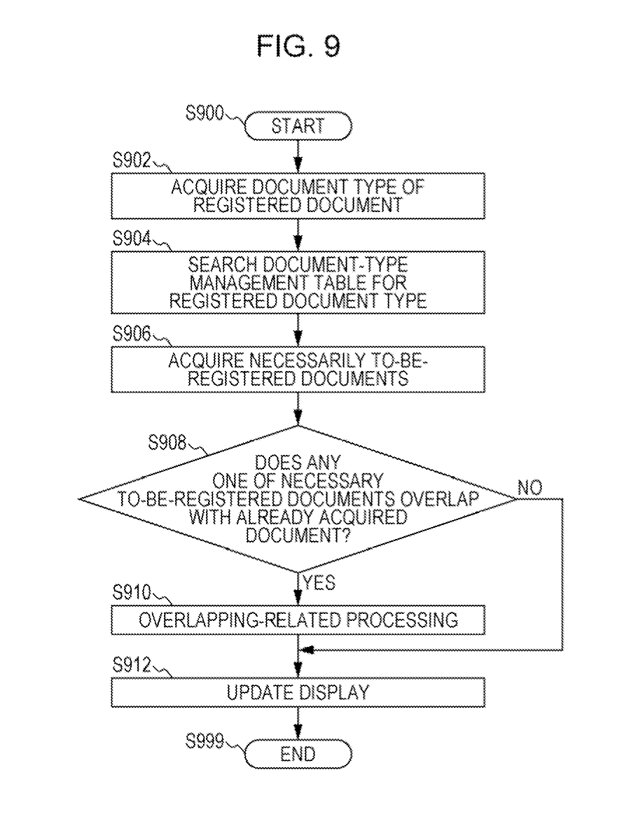

FIG. 9 is a flowchart illustrating an example of processing according to the exemplary embodiment. FIG. 9 illustrates details of the overlapping-related processing and steps including steps S908 and S910 added to the flowchart illustrated in the example in FIG. 6.

In step S902, the document-type acquiring module 135 acquires the document type of a registered document.

In step S904, the searching module 140 searches the document-type management table 700 to retrieve the registered document type.

In step S906, the required-document acquiring module 145 acquires necessary to-be-registered documents.

In step S908, the required-document acquiring module 145 determines whether any one of the necessary to-be-registered documents overlaps with an already acquired document. If overlapping is determined to be present, the processing proceeds to step S910. In the other cases, the processing proceeds to step S912.

In step S910, the required-document acquiring module 145 performs the overlapping-related processing. Here, the required-document acquiring module 145 performs processing in which overlapping extraction is not performed. Thus, a necessary to-be-registered document that is the same as the document acquired in step S906 is not displayed in next step S912.

In step S912, the displaying module 160 updates the display.

FIG. 10 illustrates a data structure example of the document-type management table 1000 obtained by adding a registration-acceptable-period column 1025 and a registration-acceptable-period column 1035 to the document-type management table 700.

The document-type management table 1000 has a document-type-code column 1010, a document-type-name column 1020, the registration-acceptable-period column 1025, a necessary-to-be-registered-document column 1030, and the registration-acceptable-period column 1035. The document-type-code column 1010 has document-type codes stored therein; the document-type-name column 1020 has document-type names assigned to the respective document-type codes; the registration-acceptable-period column 1025 has registration-acceptable periods in which documents corresponding to the respective document-type codes are required to be registered; the necessary-to-be-registered-document column 1030 has documents (necessary to-be-registered documents) required to be registered in conjunction with registration of each document assigned the corresponding document-type code; and the registration-acceptable-period column 1035 has registration-acceptable periods in which the necessary to-be-registered documents are required to be registered. Here, each registration-acceptable period is, for example, a period starting from the day a document is registered.

If the current date and time falls within a predetermined period (for example, a three-day period starting three days before the last day of the registration-acceptable period and expiring on the last day) in the registration-acceptable period, an alert indicating the presence of the necessary to-be-registered documents required to be registered is presented by utilizing the registration-acceptable period in the registration-acceptable-period column 1035. Further, if the registration-acceptable period expires, another alert may be displayed. For example, the alert may be displayed in red three days before the last day and may be dynamically displayed in a blinking manner after the last day. Alternatively, e-mail or the like may be used to notify a superior of an operator or a manager of the alert.

Note that the document-type management table 1000 may be obtained by adding only the registration-acceptable-period column 1035 to the document-type management table 700 (the registration-acceptable-period column 1025 may be deleted from the document-type management table 1000).

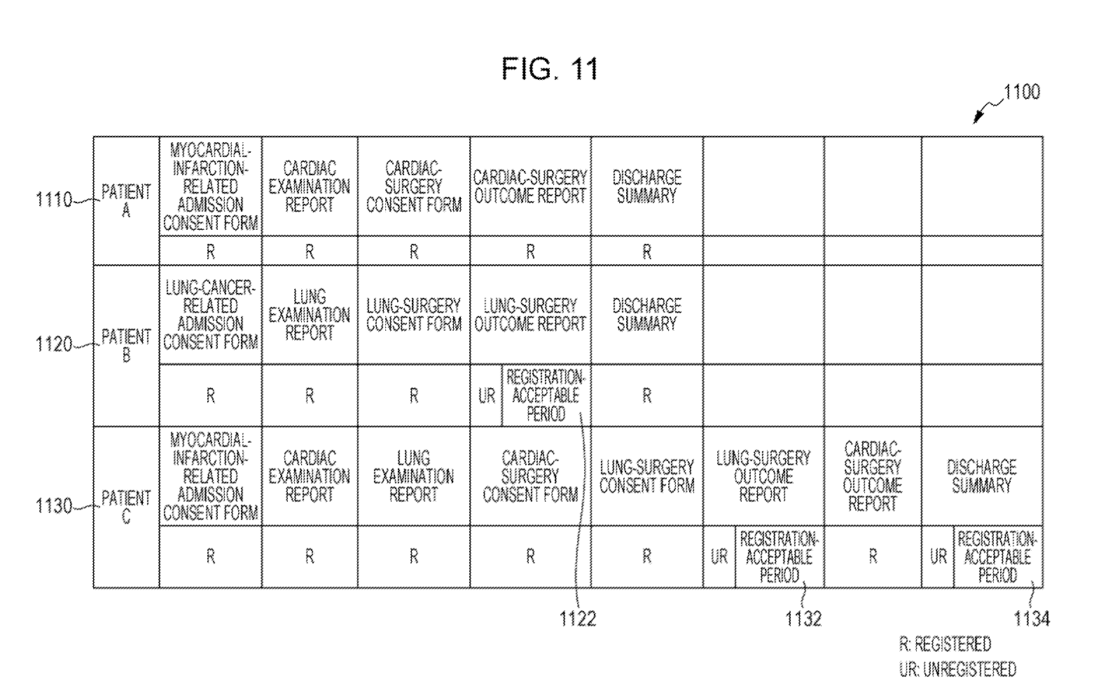

A description is given of displaying operation performed by the displaying module 160 in a case where registration-acceptable periods are managed. FIG. 11 illustrates an example of a document-registration-state screen 1100. The document-registration-state screen 1100 is obtained by providing registration-acceptable-period fields for the document-registration-state screen 800 illustrated in the example in FIG. 8. Specifically, for documents yet to be registered, the document-registration-state screen 1100 displays registration-acceptable-period fields (a registration-acceptable-period field 1122 of a lung-surgery outcome report in a patient-B row 1120, a registration-acceptable-period field 1132 of a lung-surgery outcome report in a patient-C row 1130, and a registration-acceptable-period field 1134 of a discharge summary in the patient-C row 1130). As described above, an alert indicator may be used for the registration-acceptable-period fields in accordance with a relationship between the current date and time and the last day of the registration-acceptable period.

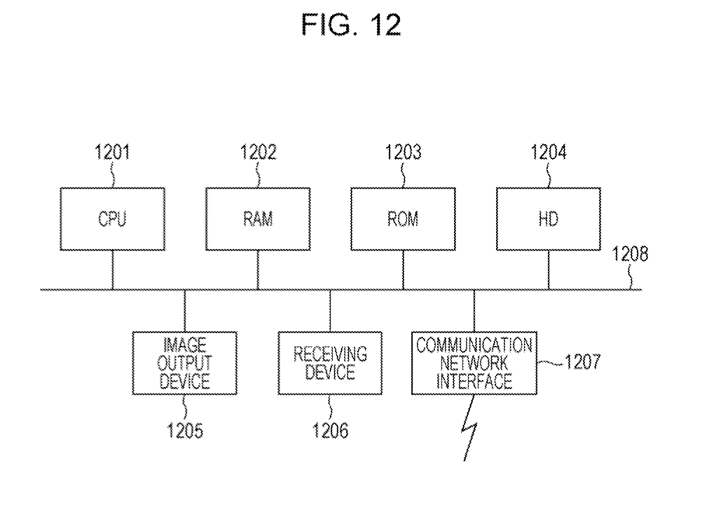

Meanwhile, a computer that executes a program according to the exemplary embodiment has a hardware configuration of a general computer, as illustrated in FIG. 12, specifically, a personal computer, a computer enabled to serve as a server, or other computers. In a specific example, the computer uses a CPU 1201 as a processing unit (arithmetic operation unit), and a RAM 1202, a ROM 1203, and an HD 1204 as storage devices. The computer may use, for example, a hard disk as the HD 1204. In addition to the CPU 1201, the RAM 1202, the ROM 1203, the HD 1204, the computer includes a receiving device 1206, an image output device 1205 such as a cathode-ray tube (CRT) or a liquid crystal display, a communication network interface 1207 for connecting to a communication network such as a network interface card, and a bus 1208 for connecting these components to exchange data. The CPU 1201 executes programs such as the patient registering module 110, the document registering module 120, the document processing module 130, the document-type acquiring module 135, the searching module 140, the required-document acquiring module 145, the registration-acceptable-period processing module 150, and the displaying module 160. The RAM 1202 stores therein the programs and data. The ROM 1203 stores therein a program for starting the computer and the like. The HD 1204 is an auxiliary storage device (may be a flash memory or other device) having the functions of the document storing module 115 and the document-type-management-data storing module 155. The receiving device 1206 receives data in accordance with user input via a keyboard, a mouse, a touch panel, or another device. Multiple computers each serving as the computer above may be mutually connected through a network.

The exemplary embodiment regarding the computer program described above is implemented in such a manner that a system in the hardware configuration described above reads computer programs that are software, i.e., in such a manner that the software and the hardware resources work in cooperation with each other.

The hardware configuration in FIG. 12 merely illustrates a configuration example, and the exemplary embodiment is not limited to the configuration in FIG. 12. As long as a configuration enables the modules described in the exemplary embodiment to be run, the configuration may be employed. For example, at least one of the modules may be configured to run on hardware dedicated to the module (such as an application specific integrated circuit (ASIC)). At least one of the modules may be in an external system to be connected through a communication network. Further, multiple systems each serving as the system in FIG. 12 may be mutually connected through a communication network to work in cooperation with each other. In particular, the configuration may be incorporated in not only a personal computer but also a copier, a fax machine, a scanner, a printer, a multifunctional product (image processing device having two or more functions of a scanner, a printer, a copier, a fax machine, and other devices). In particular, documents may be registered by using a scanner.

Note that the exemplary embodiment described above may use techniques in a related art for processing performed by the modules.

Note that the program described above may be provided by using a recording medium having the program recorded therein, and may be provided by using a communication unit. In this case, for example, the program described above may be regarded as an exemplary embodiment of the invention of a “non-transitory computer readable medium having a program recorded therein”.

The “non-transitory computer readable medium having a program recorded therein” refers to a computer readable recording medium having a program recorded therein that is used for installation, execution, distribution, and the like of a program.

Examples of the recording medium include a digital versatile disk (DVD) supporting “DVD-R, DVD-RW, DVD-RAM, and the like” that are standards designated by the DVD Forum and “DVD+R, DVD+RW, and the like” that are standards designated in accordance with “DVD+RW; a compact disc (CD) such as a CD read-only memory (CD-ROM), a CD recordable (CD-R), a CD rewritable (CD-RW), or the like; a Blu-ray (registered trademark) disc; a magneto-optical disk (MO); a flexible disk (FD); a magnetic tape; a hard disk; a ROM; an electrically erasable and programmable ROM (EEPROM (registered trademark)); a flash memory; a RAM; and a secure digital (SD) memory card.

The aforementioned program or part of the program may also be saved on the recording medium to be stored or distributed. The program or part thereof may be transmitted through communication by using a transmission medium such as a wired network used for a local area network (LAN), a metropolitan area network (MAN), a wide area network (WAN), the Internet, an intranet, an extranet, or the like; a wireless communication network; or a combination of these. Alternatively, the program or part thereof may be transmitted by using carrier signals.

Further, the program may be part of another program, or may be saved on a recording medium together with another program. The program may also be divided to be saved on multiple recording media. The program may be saved in any manner such as by being compressed or encrypted, as long as the program is restorable.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiving unit that receives at least one document related to a treatment administered to a patient;
an acquiring unit that acquires a type of the document received by the receiving unit;
an extracting unit that extracts, from an association memory that stores a type of a first document and a type of a second document in association with each other, a type of a second document associated with the type of the document acquired by the acquiring unit, the second document being to be registered in a case where the first document is registered; and
a presenting unit that presents the type of the second document extracted by the extracting unit for a document to be registered in conjunction with the document of the type acquired by the acquiring unit.

2. The information processing apparatus according to claim 1, wherein
the at least one document comprises plurality of documents, and in a case where the receiving unit receives the plurality of documents and where the type of the second document to be extracted by the extracting unit overlaps with an already extracted type of the second document, extraction in an overlapping manner is not performed.

3. The information processing apparatus according to claim 1, wherein
the association memory further stores a registration-acceptable period in which the second document is to be registered, and
in a predetermined period in the registration-acceptable period, the presenting unit presents an alert indicating presence of the second document to be registered.

4. The information processing apparatus according to claim 2, wherein
the association memory further stores a registration-acceptable period in which the second document is to be registered, and
in a predetermined period in the registration-acceptable period, the presenting unit presents an alert indicating presence of the second document to be registered.

5. An information processing method comprising:
receiving at least one document related to a treatment administered to a patient;
acquiring a type of the received document;
extracting, from an association memory that stores a type of a first document and a type of a second document in association with each other, a type of a second document associated with the acquired type of the document, the second document being to be registered in a case where the first document is registered; and
presenting the extracted type of the second document for a document to be registered in conjunction with the document of the acquired type.

6. A non-transitory computer readable medium storing a program causing a computer to execute a process for processing information, the process comprising:
receiving at least one document related to a treatment administered to a patient;
acquiring a type of the received document;
extracting, from an association memory that stores a type of a first document and a type of a second document in association with each other, a type of a second document associated with the acquired type of the document, the second document being to be registered in a case where the first document is registered; and
presenting the extracted type of the second document for a document to be registered in conjunction with the document of the acquired type.
